(19) United States
(12) Patent Application Publication
(10) Pub. No.: US 2004/0100944 A1
(43) Pub. Date: May 27, 2004

(54) Serial ATA frame structure routing circuitry and protocols

(76) Inventors: Scott Richmond, Boulder, CO (US); David Eugene Woodral, Walnut, CA (US); Frank Salvatore Palumbo, Chino, CA (US); Klaus-Peter Deyring, Scotts Valley, CA (US); James Rubino, Santa Cruz, CA (US)

Correspondence Address: RONALD CRAIG FISH, FALK & FISH, POST OFFICE BOX 2258, MORGAN HILL, CA, 95037, US

(21) Appl. No.: 10/306,350

(22) Filed: Nov. 27, 2002

(51) Int. Cl. H04L 12/28

(52) U.S. Cl. 370/360; 370/445

(57) ABSTRACT

A topology and devices and protocols comprising a switched fabric which allow attaching multiple mass storage devices through said switched fabric over any serial point to point mass storage interface. This switched fabric interface uses one or more point to point serial interfaces, such as Serial ATA to provide the connectivity of multiple drives to one or more ports on a server or PC class computer and includes routers which use router headers in FIS to establish routes and guide data. Disclosed are the switch concept, switch ASIC devices, and switch firmware in a switch supporting any number of host connections and number of drive connections. The protocols disclosed also provide the ability to connect multiple hosts to a bank of switch mass storage devices. The processes disclosed includes protocol conversions from Serial ATA 2.xx to Serial ATA 1.xx devices. A smart FIFO is disclosed which saves memory by the removal of unused primitives from the input stream, and conditionally re-inserting them into the output stream.

### BACKGROUND OF THE INVENTION

Domestic priority to a prior provisional application serial No. 60/334,448 is hereby claimed. Serial ATA was developed as a standard bus protocol to connect host computers to storage devices. This less expensive bus protocol was developed to avoid the expense of Fibre Channel Arbitrated Loop, gigabit Ethernet and SCSI technology.

The original serial ATA was a point-to-point protocol and bus structure form communications between host computers and disk drives on a point-to-point basis. Serial ATA was developed as a lower cost alternative to SCSI and Fibre Channel buses. However, serial ATA, as originally conceived did not allow for more than one device such as a disk drive to be coupled to the serial ATA bus interface of a host computer (called a Host Bus Adapter in serial ATA parlance). Since both SCSI and Fibre Channel allowed multiple devices to be coupled to the same host, this limitation was a disadvantage.

In the prior art, U.S. Pat. No. 5,107,489 to Brown et al. taught the use of a dynamic switch and protocol for establishing dynamic connections in a link by the use of frames, each frame having therein an identification of the source of the frame, an identification of the destination of the frame for the requested connection and link control data to maintain, initiate or terminate a connection between the source and the destination. The frames are bounded by start of frame delimiter and an end of frame delimiter which may also act as a connect link control and a disconnect link control, respectively. Connections are made through the dynamic switch having dynamic switch ports. The state of the dynamic switch port is changed dependent upon its present state, the dynamic connection requested, and the direction and type of frames pass through the dynamic switch port.

The Brown et al. technology fails to address the needs for expansion of the serial ATA topology and protocol.

Thus, there has arisen a need for a fabric switch technology and protocol that can expand a serial ATA bus to allow one or more host bus adapters, i.e., HBAs, to communicate with a plurality of different serial ATA devices, which are typical disk drives.

### SUMMARY OF THE INVENTION

The serial ATA route aware switch fabric allows expansion of the point-to-point serial ATA protocol to allow one or more host computers to communicate bidirectionally with a plurality of serial ATA devices. This is done using a superset of the serial ATA protocol and routers/switches which understand a routing Frame Interface Structure (hereafter a Frame Interface Structure will be referred to as a FIS and a routing Frame Interface Structure will be referred to as a routing FIS) and implement a protocol to use the routing information in the FIS to set up routes for each exchange. The routing data is prepended to the data FIS along with an RTX primitive and some CRC data and a closing primitive to convert a serial ATA 1.xx data FIS to a serial ATA 2.xx route FIS.

Also disclosed is a collision resolution protocol that uses header transmission only. The idea is to send headers only to the destination device to make sure the path is clear and there will not be collisions, and, if a successful connection is made, the payload data is sent. If a collision occurs, the complications of buffering payload data at the RSM where the collision occurred to prevent losing the data or complicated re-transmission protocols are avoided. When a collision occurs, one of the initiating nodes backs off a pseudorandom amount of time and tries its transmission again later.

Also disclosed is a protocol conversion process which allows a legacy serial ATA 1.xx device which is not route aware to be connected to a topology of serial ATA 2.xx devices which are route aware. Serial ATA 2.xx primitives are converted to serial ATA 1.xx primitives before they are sent to legacy devices. Route header information in serial ATA 2.xx devices and any other information a legacy device would not understand are stripped from serial ATA 2.xx FIS before they are passed to legacy devices. Upstream legacy FIS from legacy devices being sent to a route aware host have reverse route headers generated by the routers (RSM) from the forward route header data (which was stored after being stripped off). The reverse router header data is prepended to data FIS being sent upstream from a device to a host. Serial ATA 1.xx primitives are converted to serial ATA 2.xx primitives if necessary, but usually it is not necessary since 2.xx devices understand serial ATA 1.xx devices.

Also disclosed is a smart FIFO which is used in each RSM routing switch which deletes certain serial ATA primitives altogether and eliminates duplicate primitives before storing the incoming data, and then recreates them on the output stream.

### BRIEF DESCRIPTION OF THE DRAWINGS

FIG. 1 is a block diagram of a typical new serial ATA topology.

FIG. 2 is a diagram of a prior art seral ATA 1.x FIS FIG. 3 is a diagram of a routing FIS according to the teachings of the invention which is not appended to a data FIS.

FIG. 4 is a diagram of a new format routing FIS according to the teachings of the invention which is appended to the data FIS.

FIG. 5 is an FIS transmit example.

FIG. 6 is the discovery protocol to discover legacy devices.

FIG. 7 is a high level block diagram of a 4-port RSM router used in the invention.

FIG. 8 is an exemplar serial ATA topology to illustrate the collision protocol.

FIGS. 9A and 9B are a flow chart of the sequence of events that show how a collision occurs, and how it is resolved in a header only transmission scheme.

FIG. 10 is a block diagram of the Smart FIFO at each port of an RSM.

FIG. 11 illustrates the process carried out to not store those primitives that are un-necessary by simply not storing them in the FIFO buffer.

FIG. 12 is a flowchart which shows how the output stage of the smart FIFO replicates the last code word output from the FIFO when an empty condition is detected.

FIG. 13 illustrates a typical topology where a 1.xx storage device 184 is coupled through an RSM 186 to a 2.xx host bus adapter 188 and host computer.

FIGS. 14A through 14C illustrate the protocol conversion steps of a downstream transaction from a serial ATA 2.xx host to a serial ATA 1.xx storage device and a second upstream transaction from the serial ATA 1.xx device to the same serial ATA 2.xx host which initiated the first transaction.

### DETAILED DESCRIPTION OF THE PREFERRED AND ALTERNATIVE EMBODIMENTS

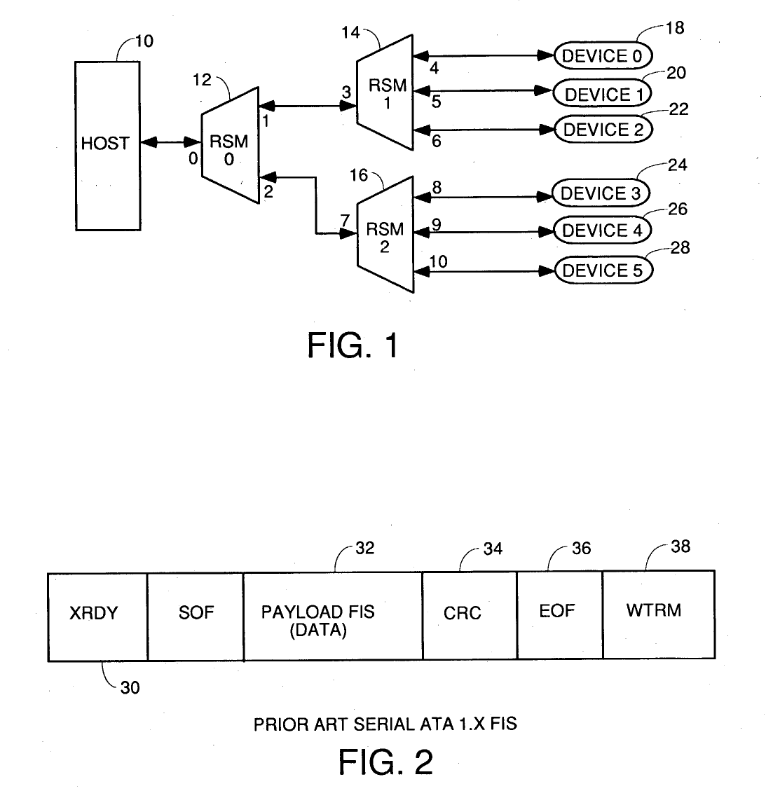

The original serial ATA specification was a point to point topology and protocol where one source could transmit data to one destination. This was too limiting, so this invention resulted. The idea behind this invention is to allow expansion of the topology to allow one physical connection from a host computer to be used to read and write data on multiple drives. Serial ATA routing packets and a new protocol and RSM routers that understand the protocol and use the routing packets to get data to and from the appropriate end points are used to accomplish this new type of serial ATA connection. How this works will be explained with reference to FIG. 1.

Referring to FIG. 1, there is shown a typical serial ATA topology according to the invention wherein a host computer 10 can communicate with any one of six devices (typically hard disks) shown at 18, 20, 22, 24, 26 and 28. This differs from the prior art serial ATA topology where one host could communicate with only one storage device. The switched fabric communication of FIG. 1 is done through three RSM routers 12, 14 and 16 in the embodiment shown in FIG. 1. However, the genus of the invention is defined by the use of as few as one RSM router to couple one or more hosts to more than one other device using serial ATA protocol as modified to read routing data in a route control FIS and form the appropriate data path. Multiple hosts can each communicate with a selected one of multiple devices through a tree of RSM routers. Legacy (Serial ATA 1.xx devices) serial ATA devices may be included in the topology and need not be aware of the presence of the RSM routers. Serial ATA 2.xx devices are router aware, and the RSM routers perform speed matching and flow control. A protocol conversion process disclosed elsewhere herein allows Serial ATA 1.xx devices to be coupled to Serial ATA 2.xx systems.

### Routing Protocol Rules

A route control FIS is used to establish a connection between multiple devices. A Sub Decode field in the header of the route control FIS indicates whether the route should be traversed in the forward or reverse direction. There is no real significance to the direction, it is strictly a relative term applicable to the current connection in reference to the host. The route control FIS is sent from a route awere originating device (host, router, etc.) and is propagated along a path from route aware device to route aware device. A port ID stored in the route FIS structure defines the desired route path. Each route aware device along the path may or may not have multiple serial ATA ports that it supports.

A route aware device receives this FIS in a standard serial ATA handshake via one of its serial ATA ports. It absorbs the entire FIS and verifies correct communication before processing the FIS.

The routing is done using route control FIS packets and ports in the RSM routers which modify the routing FIS packet as it passes through the ports to define the return path. In other words, as the route FIS is passed through an RSM, the route list is modified as follows:

1) the output port of ID of the currently selected port is modified to reflect the ID of the input port at which the route FIS arrived from the requester thereby enabling reconstruction of the return path;

2) the Active Port ID bit is cleared for the currently reported port ID and moved to the next sequential port in the route list.

For a forward route FIS, the active bit moves from top to bottom as the FIS progresses along the route path from Host to Device. For a reverse route FIS, the active bit moves from bottom to top as the FIS progresses along the route path from device to host.

After reception at the incoming port for a forward route:

1) the route list is searched for the entry indicating the active port within the route type;

2) if the Configuration bit and the End Of Table bit are set in the Route Type field, then this port is to be the target of a subsequent configuration data transfer;

3) if the End of Table bit is set, this indicates this device is the “target”, and if the end of table bit is set at the port of an RSM, that means the RSM is coupled to a legacy target device which is not route aware (The preferred alternative embodiment is to send a FIS to RSM port ff as the endpoint to signal the end of the route);

4) otherwise, the End of Table bit is false, and the RSM must forward the FIS to the next port on the list; to do this, the following steps are performed:

a) the FIS is temporarily saved;

b) a connection request is made to the designated output port;

c) the selected output port ID is changed to reflect the requesting input port ID;

d) if the End of Table bit is true, then this port is to be used for a subsequent data transfer and may be attached to a legacy serial ATA device;

e) the currently addressed port is used as the “target” if the End of Table bit is set identifying this port as the last in the list (this particular port has some device like behavior or is attached to a legacy device that is not route aware)

f) if the End of Table bit is false, then the active port location is moved to the next port ID in the list; and

g) the new FIS is then transferred to the next port ID in the list.

After reception at the incoming port for a reverse route FIS:

1) the route list is searched for an entry indicating the active port is within the route type;

2) otherwise, the End of Table bit is false and the RSM must forward the FIS to the previous port in the modified route list; to do this, the following steps are performed:

a) the modified FIS created during the forward route FIS is retrieved;

b) a connection request is made to the previously identified input port;

c) the selected output port ID is changed to reflect the requesting output port ID for the route to be re-established;

d) the active port location is moved to the previous port ID in the list; and

e) the new FIS is then transmitted to the previous port ID on the list.

The modified FIS is now ready for processing by the outgoing port, as specified in the saved port ID. If a connection cannot be made to the outgoing port (because the port is connected and busy), the FIS is held until the outgoing port becomes available. Once the outgoing port is available, the connection (within the RSM) is established and the route FIS is now “associated and processed” by the outgoing port. Obviously, the CRC must be recalculated prior to transmitting the FIS.

For example, suppose host 10 wants to read data from device 26. To do this, the host 10 generates a route FIS which defines the forward path between the host and device 26 in terms of the port numbers on the RSMs that the outbound packets need to be directed to to get to device 26. The route FIS so generated, like all route FIS, contains a FIS type, and indication of whether it is for a forward or reverse route, an active route bit and an end of table bit. The route type data in the FIS contains the active port and the end of table bits. Port IDs in the routing table in the FIS are 8-bit fields that indicate to which port the incoming route FIS is establishing a connection. The FIS essentially contains a routing table which defines the entire forward route (up to 7 RSMs deep with approximately 7×10¹⁶ total ports addressable with each RSM having up to 256 serial ATA ports) in terms of port numbers when it starts out from the source device. The route FIS is then forwarded through the architecture from the host to the device in the manner described above to establish the route and change the route FIS routing table data to point to the reverse route so that it may be re-constructed.

More specifically, in the example, the forward route FIS generated by the host will contain data (any format can be used in various embodiments) that define a forward route from port 0 to port 2 of RSM 0 and from port 7 to port 9 of RSM 2. The RSM router decodes the route FIS, and does nothing if this node is the endpoint of the route, or sends the route FIS to the next device in the chain after modifying the port ID and the active bit.

After a connection is established, the RSMs “disappear” from the actual transaction and the host and device communicate as if operating in a standard, direct connect serial ATA topology.

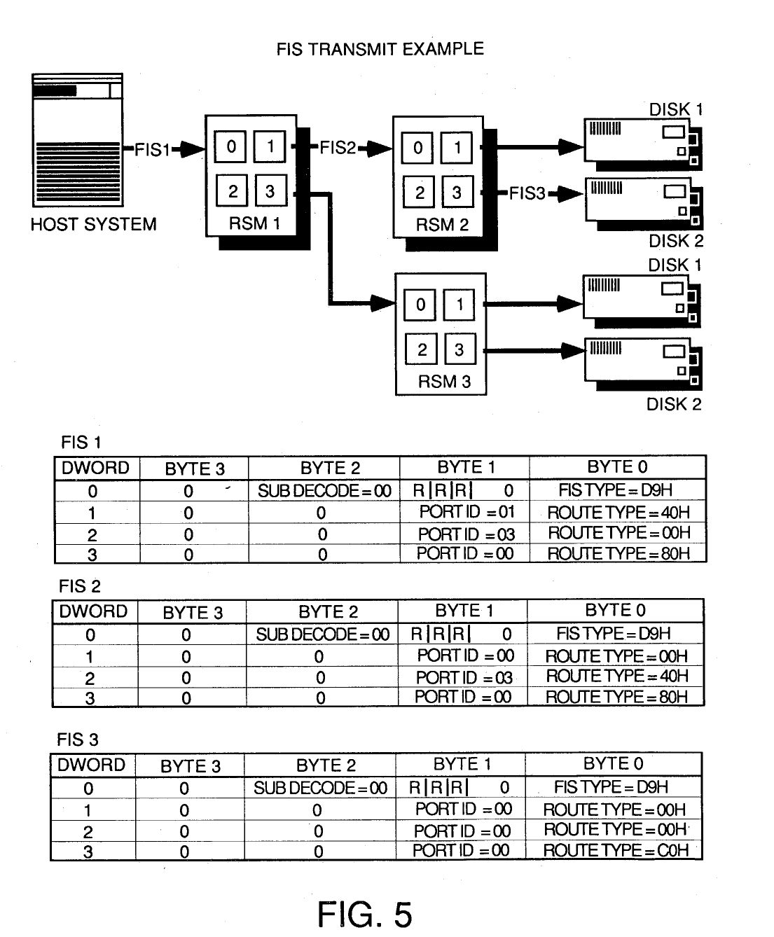

FIG. 5 is an FIS transmit example.

### New Primitives

The RTX Primitive is used in place of the conventional X_RDY primitive to initiate a route FIS data transfer. The intent of the primitive is to inform any routing intelligence that the following FIS after the primitive is of the type that contains a route header.

The H_RDY Primitive is used as one of two possible responses to the RTX Primitive. The H_RDY Primitive communicates that the FIS initiator may transmit the route header portion of the FIS. The second response to a RTX is the R_RDY primitive which communicates that the FIS initiator may transmit the entire FIS contents including the route header and the data portion.

The R_NAK primitive's purpose is to facilitate the ability of an RSM to re-transmit an FIS that was received with a CRC error. The R_NAK primitive is a third alternative primitive that may be sent instead of the R_OK or the R_ERR primitive. The R_NAK primitive means that there was some form of error with an FIS that was received other than a CRC error. The R_NAK primitive is sent to indicate that no re-transmission of an FIS should occur in order to recover from a CRC error.

The LOCK Primitive communicates to the RSM that the last path through the RSM is to remain busy until the next FIS traverses that route, and does not contain the LOCK Primtive.

### Modification of Route FIS as it Propagates

On the point of modification of the route FIS as it passes through the topology, consider the following. As the route FIS passes through each port, the routing table in the FIS is modified to define the reverse path. As seen in the protocol conversion section to allow legacy serial ATA devices to talk to route aware serial ATA 2.xx devices, the routing table header data in a 2.xx FIS is stored in a buffer in the RSM after it is stripped off the 2.xx FIS to convert it to a 1.xx FIS which can be sent to a legacy device. This allows response primitives coming back from the legacy device (which have no destination address therein) to be correctly routed to the host which sent the 2.xx FIS. The forward route FIS route header data is also converted to reverse route FIS header data which can be prepended to data FIS transmitted upstream by legacy devices. The reverse route FIS header data is not modified as it propagates upstream.

For example, as the forward route FIS passes through port 2, it is modified in the part of the table that pertains to the route through RSM 0 to point to a reverse path from port 2 to port 0. The same thing happens at port 9. When the forward route FIS passes through port 9, the part of the routing table pertaining to the path through RSM 2 is changed to point to a reverse path from port 9 to port 7. When the route FIS reaches device 26, the data in the FIS that indicates it is a forward route FIS is changed to indicate it is now a reverse route FIS. This modification of the route FIS as it passes through the topology is not taught in the Brown et al. prior art. The path through the topology in the forward direction is not locked until the return FIS propagates through it. After the forward route FIS passes through a port, that port is free to switch to other routes and is not required to wait for the reverse route FIS to pass back through it in the opposite direction. Route locking may be done by sending a LOCK primitive.

The RSMs do not need to maintain routing tables since the routes are recorded in the FIS data. The host maintains routing tables so it can initiate route FIS generation, and if the storage devices need to initiate route FIS generation, their controllers will also need to maintain routing tables. The RSMs are just smart switches that know how to read the routing table data in each routing FIS and switch accordingly.

Scalable topologies may be built from simple multiplexer type topologies with a single RSM that allows only one active route between their ports at any particular time to more complicated switches that allow multiple simultaneous paths and dynamic routing. The basic control mechanisms and routing protocol apply to all topologies.

FIG. 2 is a diagram of a prior art serial ATA FIS for version 1.x of the serial ATA specification. Field 30 is the conventional XRDY primitive. Field 32 is the payload FIS that contains the data to written or read. Field 34 is the CRC error detection and correction bits. Field 36 is the end of field data which delimits the end of the packet, and field 38 is the conventional WTRM primitive.

FIG. 3 is a diagram of a non appended route control FIS used in the protocol and apparatus of the invention. This route control FIS contains routing data therein which defines the route from the host to the desired device and which is changed as the route control FIS is sent through the topology before the data is sent to define the reverse path. The route control FIS is used to define and activate a connection between route aware devices.

The route control FIS is comprised of multiple segments. Segment 0 contains a FIS type field 40. The FIS type field is set to a value of D9 (hex), and this defines the rest of the fields and defines the length of the FIS as n+1 D words. A Sub Decode field 90 further identifies the FIS type as either a forward route FIS (00 hex), a reverse route (01 hex) or a FIS which clears all route information (02 hex) associated with each port in the route specified in the routing table fields (port ID and Route Type). Segments 1 through n contain port ID and route type fields of which fields 42 and 44, respectively, are typical. The segments define the route from top to bottom of the port connections in each RSM to establish a forward path from the host to the target device. A reverse route FIS re-establishes a previously suspended route from a device or mid point RSM back to the host. Each segment with a port ID field defines the output port of the RSM to which the switching circuitry of the RSM corresponding to that level should direct the FIS.

The Route Type fields such as field 44 further define the port characteristics identified in this Dword. Bit 7 is the end of table bit. This bit, when set, identifies the port associated with this Dword as the last entry in the routing table. The target device will be coupled to this port. Bit 6 defines the active port. A one in this position enable FIS processing by the receiving port and its relative location in the routing structure. Bit 5 is the port configuration bit. This bit is used in conjunction with the end of table and active port bits to enable the currently addressed port to be used as the target for a subsequent configuration data transfer. Bits 4 through 0 are reserved for future use to further identify any particular characteristics of the route.

The port ID field 42 in each segment of the routing table holds the port number of the desired output port to route for a given route aware device.

The route control FIS is used to establish the desired connection between multiple devices. The sub decode field contents indicates whether the route list should be traversed in a forward or reverse direction.

The RSM routers do not need to be aware of the generation of the serial ATA device coupled to any port. Serial ATA 1.xx and Serial ATA 2.xx devices and RSM and hosts may be freely intermixed with no distinctive action needed on the part of the RSM other than to generate route control FIS where necessary to communication with a Serial ATA1.xx device. When a Serial ATA1.xx device is coupled to a port of an RSM, the RSM provides the route control FIS so that the Serial ATA1.xx device appears to behave properly to the rest of the Serial ATA2.xx route aware system. Serial ATA2.xx storage devices and hosts which are route aware devices require no special processing by the RSMs.

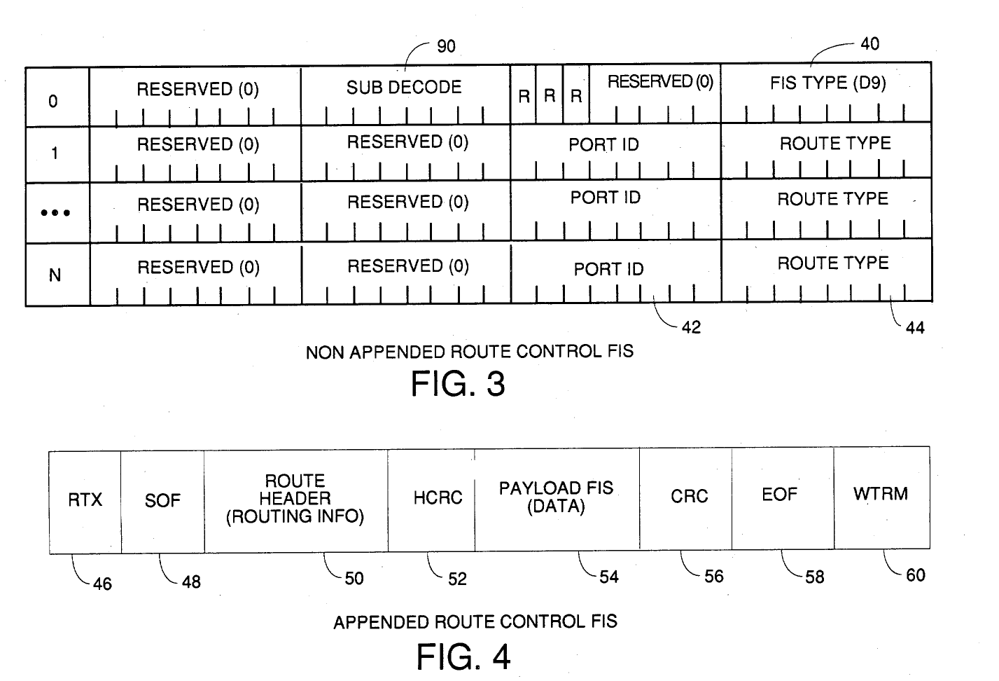

FIG. 4 is a diagram of the preferred form of route control FIS used in the protocol and apparatus of the invention where the route control information is appended in the header of the payload FIS. Field 46 is an RTX primitive that is used to signal that the header contains the route control data. Field 48 separates the primitive in field 46 from the routing table data in field 50. CRC data on the header information only, referred to as HCRC is contained in field 52. The payload data is contained in field 54, and CRC data on the payload is contained in field 56. An EOF delimiter in field 58 marks the end of the payload and the beginning of the conventional WTRM primitive in field 60.

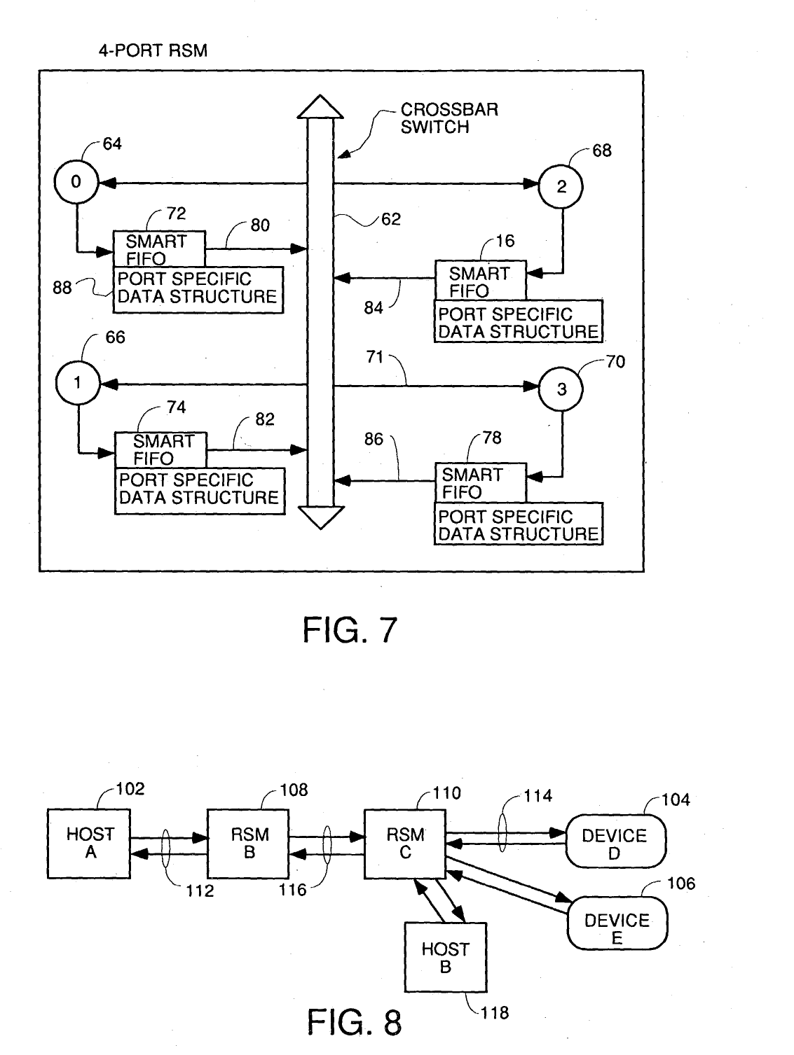

FIG. 7 is a block diagram of a typical 4-port RSM. At the heart of the RSM is a crossbar switch 62 which has connections to each of the four port circuits 64, 66, 68 and 70. The crossbar switch allows each port to be coupled to each other port, with the connections being established according to commands sent to the crossbar switch by the FIS buffer circuits. For purposes of discussion, a route is a unidirectional path, and a connection is a bidirectional path. Serial ATA requires data to flow in both directions so the protocol of the invention must establish connections.

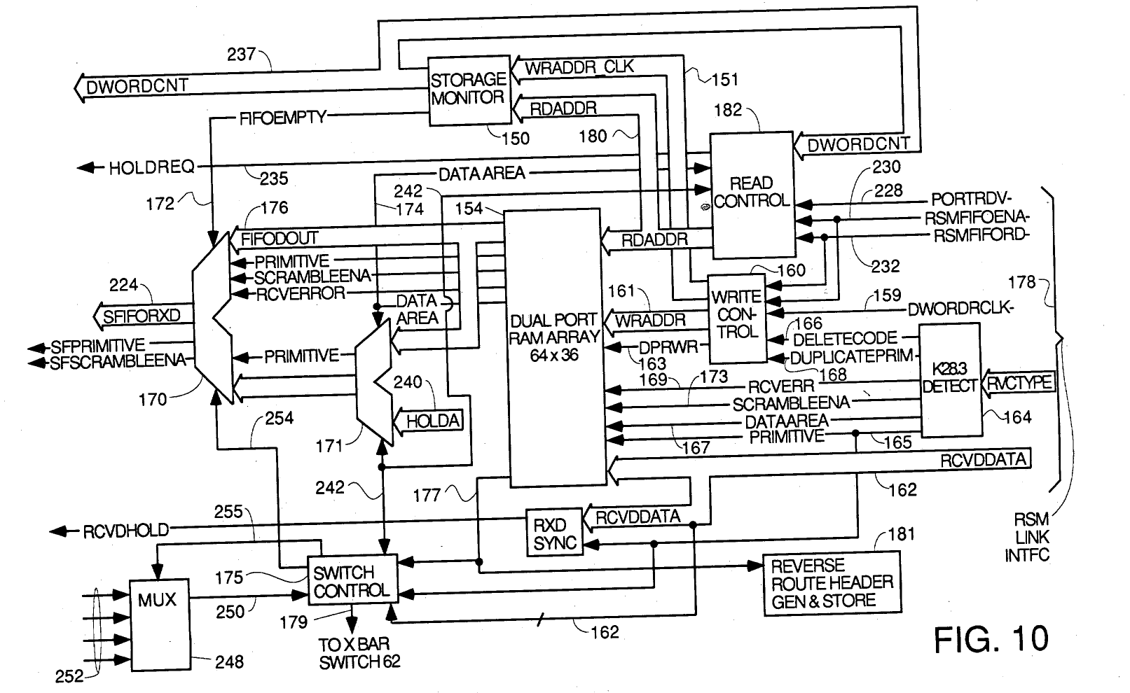

Each of these port circuits is coupled to an FIS buffer circuit, of which buffers 72, 74, 76 and 78 are typical. These buffers contain not only sufficient buffer memory to store a complete FIS other than a data FIS, but also contain the circuitry needed to implement the routing protocol described herein and the collision resolution and protocol conversion processes described herein. Any circuitry such as a programmed microprocessor or state machine that can perform the functions defined in the routing, collision resolution and protocol conversion processed described herein will suffice to practice the invention. In the preferred embodiment, the FIS buffers are the Smart FIFO circuit shown in FIG. 10, and contain enough memory to store the appended route control FIS packets such as are shown in FIG. 4. Each FIS buffer is coupled to memory storing a port specific data structure, of which block 88 is typical although this data structure may be stored in the FIS buffer and not separately shown.

Basically, each FIS buffer contains circuitry to read the port ID and route type data in the routing table of the FIS, generate suitable control signals for the crossbar switch to route the FIS to the port identified in the routing table of the FIS, and alter the route control FIS routing table port ID data to point to the proper port ID to which the FIS should be directed when it travels through the RSM in the reverse direction. In other words, each buffer circuit 72, 74, 76 and 78 contains decoder circuitry to decode the routing data in the routing header part of the FIS stored in the buffer, detect and correct any errors in the FIS header using the HCRC bits and decide which switch port to send the FIS to according to the routing data. Each buffer circuit also is coupled by a data path and control path to the crossbar switch, of which buses 80, 82, 84 and 86 are typical and contains circuitry to drive the route control FIS, any payload data FIS and any primitives onto the bus to the crossbar switch. Each buffer also contains circuitry to generate suitable control signals to control the crossbar switch to couple the route control FIS, any data FIS and any primitives to the destination port dictated by the routing information in the decoded route control FIS. Each port circuit also contains the physical interface circuitry to interface the RSM to the serial ATA physical media, and to detect when a Serial ATA 1.xx device is coupled to a port and generate a suitable route control FIS to make the Serial ATA1.xx device appear to behave properly to the rest of the system.

With regard to device/host RSM communications, at power-up it is assumed that no active connections exist in any RSM. For a host to communicate to a device, a forward route control FIS is generated in the host and sent to the device the host wants to communicate with. The route control FIS establishes the forward path to the device. As the route control FIS passes through each RSM, the RSM port circuitry determines the port to which the route control FIS should be sent and the return path by decoding the routing information in the route control FIS. This action causes the route control FIS to be sent from each RSM to the input port of the next RSM in the path. Only when the FIS is properly received at the end device with a good status is the connection from the host to the device “locked” by each RSM along the path. Any communication subsequent to this locking, other than another route control FIS, will be directed along the path established by the route control FIS. Any response by the device, other than another route control FIS, is directed back along the reverse path by each RSM until it gets back to the originating host. In order to change the connection to another device, the host would have to send another route control FIS directed to another device. Routes can be locked with the LOCK primitive. If the LOCK primitive is not used, the route is a virtual point to point connection.

Although the route control FIS of FIG. 3 can be used according to the teachings of the invention, the route control FIS of FIG. 4 is preferred because it is prepended to the payload data FIS, and this creates less overhead.

Re-establishing a connection is handled as follows. Once a path is established, it may become necessary for an RSM to suspend an idle connection creating a different path to another port. A reverse route FIS describing the path from device to host provides the mechanism for connection re-establishment. The port where the connection was suspended has the responsibility of re-establishing the original connection when the traffic flow requires it. Suspending and re-establishing a connection is transparent to other nodes along the connection path.

### Smart Fifo

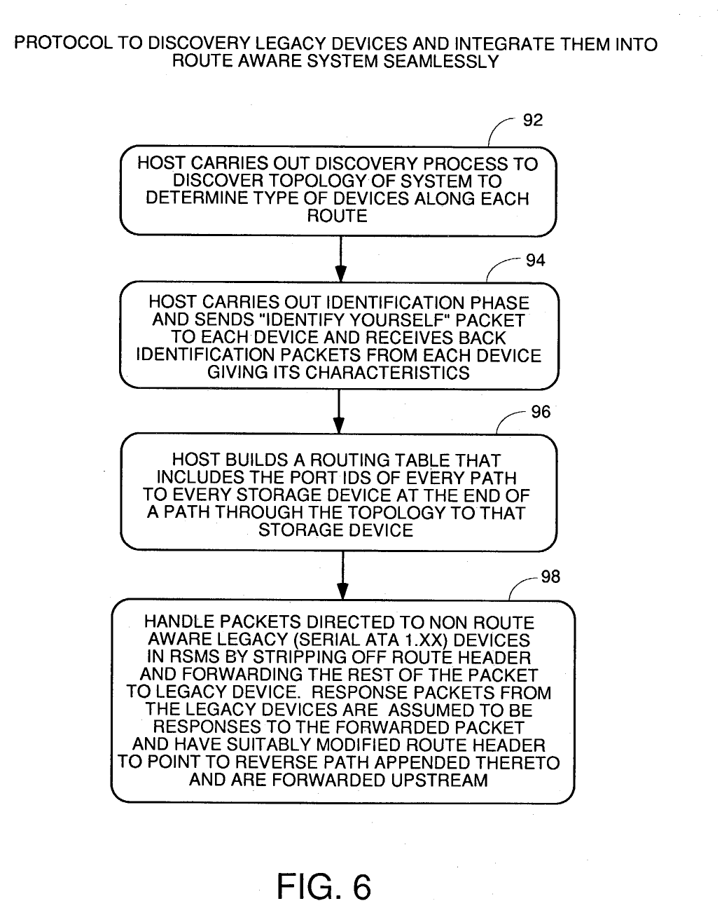

One of the innovative features of the RSM devices is their ability to recognize route control FIS that are addressed to non route aware devices and deal with them appropriately such that legacy non route aware devices can communicate through route aware RSMs to route aware hosts. This is done through a discovery protocol which includes a discovery phase, an identification phase, a routing table building phase and a phase where the RSMs examine route FIS directed to legacy devices and alter the packets in a certain way before forwarding them and handling the return packets in a certain way. This discovery protocol is shown in flowchart form in FIG. 6.

FIG. 6 is a flowchart of the phases of a genus of protocols to discover the presence of legacy non route aware devices in a route aware serial ATA system and integrate them seamlessly into the system without any manual intervention. All process species within the genus of protocols according to the protocol invention share the following characteristics. First, there will be a discovery phase to discovery what types of devices are coupled to the host and what types of devices are coupled to the device coupled to the host. Second, there will be an identification phase wherein the host addresses each device it found and determines whether it is route aware or not and determines how many ports it has if it is an RSM. Third, there will be a phase of building a routing table which includes building routes that terminate at the RSM coupled to a non route aware device and which terminate at the device itself if the device is route aware. Finally, there will be a phase of handling packets with route FIS appended thereto in such a way as to delete the route FIS of packets addressed to non route aware devices and to receive reply packets from non route aware FIS and append appropriate route FIS headers thereto before forwarding the reply packet toward the host.

In FIG. 6, step 92 represents the discovery phase wherein the host discovers the topology of the system. This phase can be carried out in any way, but in serial ATA, it is carried out by the host sending out a software reset on the serial ATA medium through its host bus adapter. The serial ATA link will either be coupled to an RSM or to a storage device which may be either route aware or non route aware. Whatever device is coupled to the host responds to the software reset by sending back a signature packet which identifies what type of device it is. This signature packet does not tell the host whether the device is route aware or not or, if it is an RSM, how many ports it has.

If the device coupled to the host is a storage device (either legacy non route aware or route aware), then the protocol is finished and none of the remaining three phases are carried out. This is because there are no routes so there is no need to build a routing table. Also, there is no need to use route FIS headers since there is only one route so there is also no need for the data handling phase to strip off route FIS headers from packets addressed to non route aware devices.

Continuing with the discovery phase, if the device coupled to the host is an RSM, the host sends a read request packet to the RSM. The RSM responds with a packet which tells the host how many ports it has and what port ID each port has. In order to find out what type of device is coupled to each port, the host then sends a packet having a route FIS header addressed to the particular port to each port. The data portion of this packet is a software reset. The host assumes that whatever device is coupled to the port is non route aware at this point to avoid sending a packet with a route FIS header appended thereto to a device which does not understand a route FIS and which will cause the software of the device to get confused. Therefore, the route FIS header of each software reset packet is stripped off the software reset packet at the RSM before the software reset is sent out the port. To accomplish this, the route FIS header of each software reset packet will have an end of table bit which indicates the end of the route is the RSM. This causes the RSM to strip off the route FIS header and forward only the software reset portion out the port to whatever device is connected thereto.

Each device coupled to a port then responds with a signature packet that identifies what type of device it is. If a port is coupled to a storage device, the discovery process for that route is complete. If a port of an RSM is coupled to another RSM, then the host repeats the process of sending a read request to learn the port IDs the RSM has, and then sends software resets to each port of that RSM, as described above. The host continues this process until a storage device is found at the end of each route since each route must terminate in a storage device. When a storage device has been found on each route, the discovery phase is complete.

After the discovery phase, the host enters an identification phase the purpose of which is to identify the capabilities of the devices in the topology discovered during the discovery phase. In this phase, a request for identification is sent to every device in the discovered topology. Assuming the device coupled to the host is an RSM, the host sends an “identify yourself” packet to the RSM. The RSM responds with an identification packet which tells the host its characteristics since all RSMs will be route aware. If the host is coupled directly to a device, an identify yourself packet is routed to the device. Again, since the host still does not know whether the device is or is not route aware, the “identify yourself” packet has an end of table bit in the route FIS which causes the route FIS header to be stripped off before the “identify yourself” portion of the packet is sent to the device. The receipt of the “identify yourself” packet at the storage device causes an identification packet to be sent back which tells the host whether the device is or is not route aware and its other characteristics.

During the identification phase, an “identify yourself” packet is sent to every device coupled to a port of every RSM at all levels until all devices in the topology have received an “identify yourself” packet. The identification process continues until every device has identified itself and informed the host of its characteristics. This allows the routing table construction phase to begin. All this identification phase processing is symbolized by block 94 in FIG. 6.

The routing table construction phase is symbolized by block 96 in FIG. 6. Using the identification packets received from each node, the host builds a routing table that includes the port IDs required to traverse a forward path through the topology to each storage device at the end of a route. Basically, each path through the topology to a storage device is mapped using the port IDs of the various RSMs that must be traversed to get to that device. Routing table data for each route that is terminated in a non route aware device has an end of table bit which indicates the end of the route is the RSM port coupled to the legacy device. This causes the RSM port circuitry coupled to the legacy device to strip off route FIS headers before forwarding packets to the legacy device and to alter those stripped off headers to point to the reverse path and append them to response packets coming back into the port from the legacy device before the response packet is forwarded. This stripping off of route FIS headers and appending of reverse route FIS headers to response packets from legacy devices is the functionality of the data phase of the protocol.

The final phase in the protocol is the data handling phase represented by block 98 in FIG. 6. The function of the data handling phase is to properly handle data packets with appended route control FIS that are directed to legacy non route aware devices in the RSMs so that these legacy devices appear to the system to be route aware devices and so that route control FIS do not get to the legacy devices to confuse them. If a data packet with an appended route control FIS is sent to a route aware device, that packet is just forwarded to the device with the route control FIS modified to point to the reverse path such that response packets from the device with this modified route control FIS traverse the reverse path through the topology to the host. If a data packet with an appended route control FIS is sent to a non route aware device, the route control FIS is stripped from the packet, and the remaining data portion is forwarded to the legacy device. This prevents the legacy device from being confused by receipt of a packet it does not understand. Assume that the packet is a read request. The requested data is then retrieved, and sent back to the RSM as a response packet. The RSM assumes that the next packet received from the storage device is a response packet to the packet the RSM just forwarded. The RSM then takes the stripped off route control header, as modified to point to the reverse path, and appends it to the response packet and forwards the newly generated packet to the appropriate next port on the reverse path. This fully integrates legacy devices which are not route aware into the newer route aware serial ATA system.

### Collision Protocol

When there was only one host and one device on a serial ATA link, collisions were not much of a problem. When multiple hosts and multiple devices exist on the same serial ATA topology, collisions become a more likely occurrence. Sometimes multiple devices that want to talk to the same device on a serial ATA network all simultaneously decide that the channel to the device is clear. If they simultaneously decide to send data to the same device, a collision occurs somewhere in the topology because somewhere there is a port of an RSM that is coupled to the device by only one path and two different initators are trying to use the same path to the same device at the same time. More precisely, a collision occurs whenever two ports attempt to talk to each other simultaneously. Each port can only send one message in one direction at any particular time. If two different initiators wish to send two different messages through the same port in the same direction at the same time, that is a collision. If a port tries to send a message in one direction to another port to which it is connected, and the port to which it is connected tries to send another message back to the first port at the same time using the return path, that also is a collision. Any type of collision requires a collision resolution back off protocol so that only one device talks to any other device over a certain path at any particular time and any other device that wants to use that path waits its turn.

The difference between the collision protocol of the invention and other collision protocols on serial ATA is that the invention protocol uses only the headers and not the entire packet. In prior art collision resolution protocols, devices would send entire packets when they decided the channel was clear, and when they discovered that a collision had occurred, all the data of the packet, its header and CRC had to be buffered to prevent loss or complicated retransmission protocols had to be implemented which needed to figure out what was lost in the collision and re-send it. Every host and device and intermediate RSM had to have sufficient buffer memory to store entire packets to prevent loss of data during a collision, and every device had to have a collision resolution protocol. The problem is multiplied by the fact that RSM devices had to have sufficient buffer and a collision resolution protocol for every port. This added substantial cost to every device.

The idea behind the header only collision resolution protocol is to eliminate the need for buffering of packets that collided (buffer memory adds cost and this is a cost sensitive market) by using a header only protocol to verify that the path is clear and that data can be sent all the way to the destination device and get a response back without collisions before committing to sending longer packets with payload data therein. When there is a collision, one device has to back off, and the header only protocol is a cheap way of implementing this back off protocol upon collision.

FIG. 8 illustrates a routed serial ATA topology which will be used to illustrate the collision resolution protocol invention. It is assumed in FIG. 8 that all devices are generation two devices that use the header only protocol of the invention. Host computer 102 is coupled to storage devices 104 and 106 via RSM 108 and 110. Each entity can only determine if the channel between it and the other device to which it is connected is clear and has no way of knowing whether any of the other paths are or are not clear. Suppose host 102 decides it wants to talk to device 104 and decides that path 112 is clear. At the same time, device 104 decides it want to talk to host 102 and decides path 114 is clear. Both host 102 and device 104 transmit simultaneously on paths 112 and 114. Host 102 sends an X_RDY primitive to RSM 108 which responds with an H_RDY meaning OK to send but send header only. This causes host 102 to send only the header of the packet to RSM 108. Device 104 sends an X_RDY to RSM 110 which responds with an H_RDY causing device 104 to send only the header of the packet it wants to send. This will cause a collision on path 116 when RSM 110 realizes from the header information that the destination is host 102 and tries to talk to RSM 108. This happens because at the same time RSM 108, realizes from the header information that the header is directed to device 104 and tries to talk to RSM 110.

To resolve this situation, either RSM 108 or RSM 110 needs to back off and try again later. Assuming that the host A to Device D (102 to 104) path wins, RSM 110 will send a primitive back to device 104 telling it to execute its back off routine. Since device 104 never sent any data, it can easily recover from the collision and neither RSM 108 nor RSM 110 needs to have expansive buffer space to store entire data packets while the collision is being resolved. To complete the transaction, RSM 108 sends the X_RDY primitive to RSM 110 which responds with an H_RDY which causes RSM 108 to send its header. The header causes RSM 110 to realize the destination is device 104, so RSM sends an X_RDY to device 104 which responds with an H_RDY. RSM 110 responds with a header only. This causes device 104 to respond with a primitive that says, “OK, send your data”. This primitive makes it back through path 114, RSM 110, path 116 and RSM 108 and path 112 to host 102 by similar hand shaking protocol. Host 102 responds by sending a data packet. This packet makes it all the way to device 104 by similar handshaking. If while this is occurring, host 118 tries to talk to RSM 110, host 118 will get a busy response and will be held off.

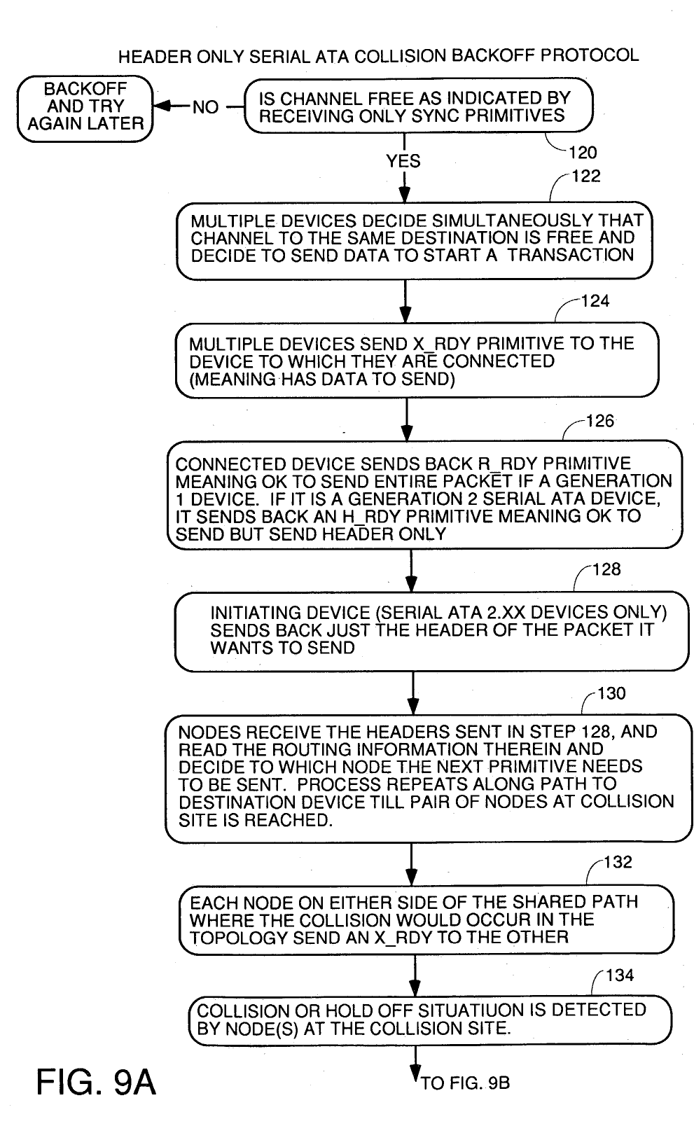

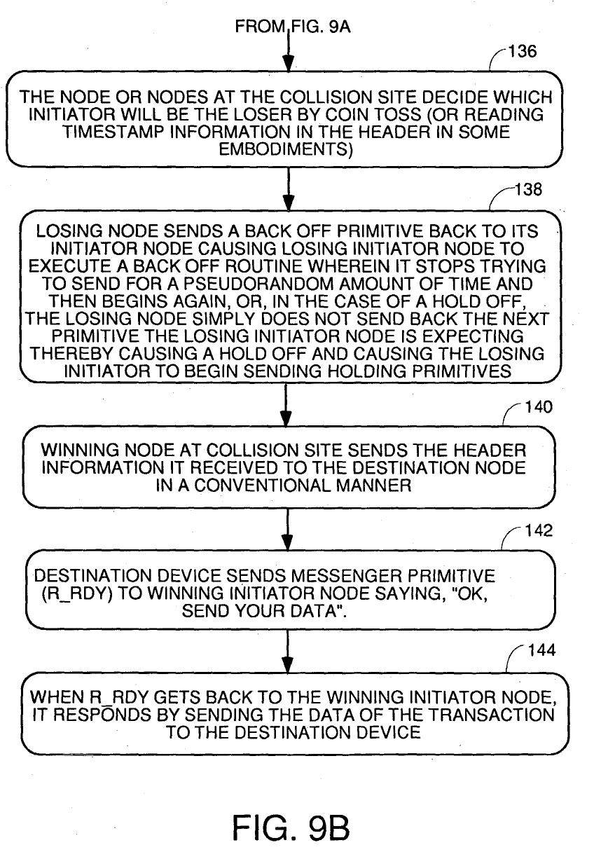

FIG. 9A through 9B illustrates the sequence of events of a typical collision and how the collision is resolved in a header only collision resolution backoff protocol. Block 120 represents the event that multiple devices determine simultaneously that the channel to the other node or entity to which they are connected along the route designated in a routing table as the route to use to talk to the destination device is not busy by virtue of receiving only sync primitives on the path to the first device in the route. This means host 102 detects only sync primitives on path 112 and device 104 detects only sync primitives on path 114. Block 122 represents the step where multiple nodes (node will be generically used to refer to hosts, RSMs or storage devices) simultaneously decide to start a data transfer transaction. In the example, host 102 decides to start a transaction with device 104 and device 104 decides simultaneously to start a transaction with host 102.

Step 124 represents the process of each device starting transactions by sending X_RDY primitives to the first node on the route. The node which receives the X_RDY responds with an R_RDY if it is a generation 1 device (meaning, “OK, send your data”) or an H_RDY (meaning, “OK, send your header only) if it is a generation 2 device.

Step 128 represents the initiator node receiving the H_RDY and responding by sending header only to the node that sent the H_RDY. In the example, host 102 would send only the header to RSM 108, and device 104 would send header only to RSM 110. This process is repeated for all links on the route to the destination device until the collision site is reached. In the example, the collision site is the single path between nodes 108 and 110.

Step 130 represents the process of each node along the two paths that will collide at some point receiving the headers and reading the routing information in the headers and deciding from the routing information to which node the next primitive (X_RDY) needs to be sent. This process continues for each node along the routes that will collide until the pair of nodes (or the single node in the case of a collision between two hosts that both want to talk to the same device at the same time) connected to the single data path on which the collision will occur receive header information that indicates a collision will occur.

Step 132 represents the process of sending an X_RDY to the next node on the path indicated in the routing information in the header from each node receiving one of the headers which indicate there will be a collision.

Step 134 represents the process of detecting this collision situation at the collision site. There is a micro collision type and a macro collision type. A micro collision occurs when two ports receive header information and realize they are each trying to talk to the other simultaneously. This is handled by a back off protocol in the ports where they decide which one will back off by exchanging messages, and then the other completes sending its header or primitive traffic to the port which backed off. A macro collision is where a port has received header information and reads the header information and realizes there will be a collision on the shared data path to the single destination or the single shared data path between the two nodes trying to send data in opposite directions. In alternative embodiments, a collision can be recognized by any other suitable means. A macro collision is handled by sending a backoff primitive to the losing initiator. As an example of a macro collision, when RSM 110 receives headers from device 104 and RSM 108, it will realize there is a collision impending on path 116. The same thing will happen if the timing is such that RSM 108 receives the headers from host 102 and RSM 110. Another example of a macro collision would be if host 102 and host 118 both decide they want to simultaneously send data to device 104 or to device 106. The collision would occur on path 114 if they both wanted to send data to device 104.

There is a difference between a macro collision and a hold off. A collision (which includes both a micro collision and a macro collision) is defined at two devices wanting to send data over the same data path at the same time. A port cannot send and receive data simultaneously, but a port can send and receive primitives at the same time.

A hold off is defined as a node receiving header information that would require use of a certain path and then receiving an X_RDY along the path that is to be used indicating another device wants to use the same path. In a hold off situation, the node that receives the X_RDY simply does not respond with an H_RDY thereby preventing the held off node from sending the header information. The difference is that in a collision, a backoff primitive is sent to the losing initator that tells it to execute a back off protocol which causes the losing initiator node to stop trying to transmit, delay some pseudorandom amount of time between a minimum and a maximum specified by the serial ATA specification (theoretically, the system will work without the minimum and maximum time limits, but for system performance reasons, a minimum and maximum amount of time is specified), and then retry its transmission starting from the beginning with an X_RDY primitive.

However, in a hold off, the initator just does not get an H_RDY primitive (or the next primitive in the handshake that the initiator is expecting) back or is sent a holdoff primitive and just delays its transmission process wherever it is in the process until it receives another primitive (H_RDY) that indicates the path is clear and it can now send its header information. A hold off can be implemented simply by not sending the next primitive in the handshake sequence which the initator needs to move forward in the transmission sequence. When an initiator is in the held state, it sends continuous holding primitives to indicate is it holding.

Step 136 represents the process of the nodes which received the colliding header information determining which initiator node will be the loser. In the example, both RSM 108 and RSM 110 receive header information which indicates there will be a collision. One or the other of them needs to decide to inform its initiator node to back off. In some embodiments, there is timestamp information in the header, and the loser initator node is decided by whichever node received the colliding information second in time. In other embodiments, the two nodes which received colliding header information would exchange messages and would execute a random “flip a coin” algorithm to decide the loser. In other embodiments, the two nodes on either side of the collision site would realize there is an impending collision by virtue of having send out an X_RDY and getting an X_RDY back from the other node. In the preferred embodiment, the exchange of X_RDYs indicates the collision, and the losing initiator node will always be the upstream node. In the example given, that would be host 102 since the upstream direction is always toward the host. In the case of a collision such as where host 118 and host 102 both simultaneously want to send data to device 104 causing a collision on path 114, RSM 110 can decide the losing host simply by doing a random flipping a coin algorithm, or looking at a table of priorities and deciding which host has lower priority or by any other means such as timestamps and first-come-first-served.

The loser, the case of a collision would then send a back off primitive to its initiator node, as symbolized by step 138. If a hold off situation is detected, the node which needs to hold off its initiator node to prevent a collision just does not send back the next primitive in the handshaking sequence the initiator node is expecting thereby causing the initiator node to be held off and start sending holding primitives to indicate its status as waiting for the next handshaking primitive in the sequence.

This resolves the collision. The final steps are to send the header information received by the winning node at the collision site to its destination in a conventional manner, as symbolized by step 140. This involves each node in the route sending an X_RDY to the next node in the route when it determines the data path to the next node is idle. The node which receives the X_RDY responds by sending an H_RDY primitive back which causes the first node to send the header information only.

When the destination node receives the header information indicating the desired transaction, it sends back a messenger primitive, which is R_RDY in the preferred embodiment, that says, “OK, send your data” as symbolized by step 142.

When the R_RDY primitive gets back to the winning initiator node (host 102 in the example), it responds by sending the data of the transaction to the destination node, as symbolized by step 144.

### Smart Fifo and Protocol Conversion

When implementing a routing structure, in which multiple devices can be linked together to form a network of devices for the purpose of transferring and storing data, the buffering of data may be required. As in any communication or serial interface technology, the presence of overhead characters, code words or primitives exist for the purpose of controlling the data transfer activity. This section describes the behavior of a Smart FIFO that is capable of determining the relative importance of the information to be stored in a buffer, such as a FIFO, and then taking the appropriate action to either store the overhead information or preventing it from being stored, hence the term Smart FIFO. Although some of the discussion in this document may refer to the Serial ATA interface standard, the reader will appreciate the application in any other standard in which overhead codes exist for the purpose of controlling the transfer of data as it travels from point to point through a network of interfaces.

There is a need in mixed serial ATA topologies for protocol conversions to allow legacy devices to talk to new route aware devices and vice versa. This section therefore also discloses a method for the transformation of Serial ATA 2.0 protocol into Serial ATA 1.0 protocol, for the purpose of attaching Serial ATA 1.0 storage devices to a Serial ATA 2.0 network, maintaining compatibility with Serial ATA 1.0 storage devices. Our preferred embodiment is the smart FIFO described above, but we recognize other methods of performing this transformation.

The Smart FIFO operates as a speed matching buffer between a receive and transmit data port which operate at different clock rates. Circuit is not limited to use in Serial ATA networks. As in most communication systems, information received by a serial interface is packed into a larger data structure such as a 32-bit DWORD. The size of the packed data structure depends upon the interface standard. This data structure includes control codes that govern the data transfer operation and user data. This information must then be passed along to a transmit side of a routing path which operates at a slightly different clock frequency. In a typical system, this slight variation between input and output clock frequencies may result in data errors within a system should the FIFO buffer over run. Overflow is caused by a higher receive data rate than transmit rate and running out of buffer. Errors can also be caused by under run as the result of a faster output data rate than input rate. The Smart FIFO prevents data errors by continually monitoring the amount of information contained in the buffer and compensating for any rate difference by:

1. Removing un-necessary control codes,

2. Reducing the number of control code words stored in the FIFO buffer, and

3. Replicating or reproducing control codes at the output of the FIFO buffer.

Regardless of whether an un-necessary or redundant code word is removed, the effect of minimizing the amount of control codes stored in the buffer, forces the FIFO to always try to achieve an empty condition. Under normal circumstances an empty FIFO 6 would create a data error. However, through direct or indirect communication from the input storage process to the FIFO output control, the replication of specific code words is possible. This replication occurs if and when a FIFO empty condition is detected. Using code word replication we prevent a FIFO read operation from causing an under run condition which would normally result in a data error.

It is at this output stage that the replication of Serial ATA 2.0 codewords (primitives) is transformed into Serial ATA 1.0 codewords. It is also at this point that Serial ATA 2.0 routing information is deleted from the output stream, and a Serial ATA 1.0 FIS is generated from a Serial ATA 2.0 FIS by the protocol conversion process.

### Storage Organization

Many data storage architectures are possible from the simplest form, which only permits code word and data storage to a more elaborate scheme, which allows for additional control bits to be stored along with the code word value. The addition of control bits, stored along with data, enables the input side of the FIFO buffer to instruct the FIFO output logic what to do under certain circumstances including the replication and insertion of code words.

Referring to FIG. 10, there is shown a block diagram of the Smart FIFO. In FIG. 10, the FIFO is organized as a 32-bit code word (data), plus additional control bits that characterize the information stored and control the output regeneration process. The additional control bits influence the actions required on the output side to correctly reproduce any primitives removed by the storage process. These control bits also are used for the transformation of Serial ATA 1.0 protocol to Serial 2.0 protocol, and vice versa in the protocol conversion process.

### Storage Control

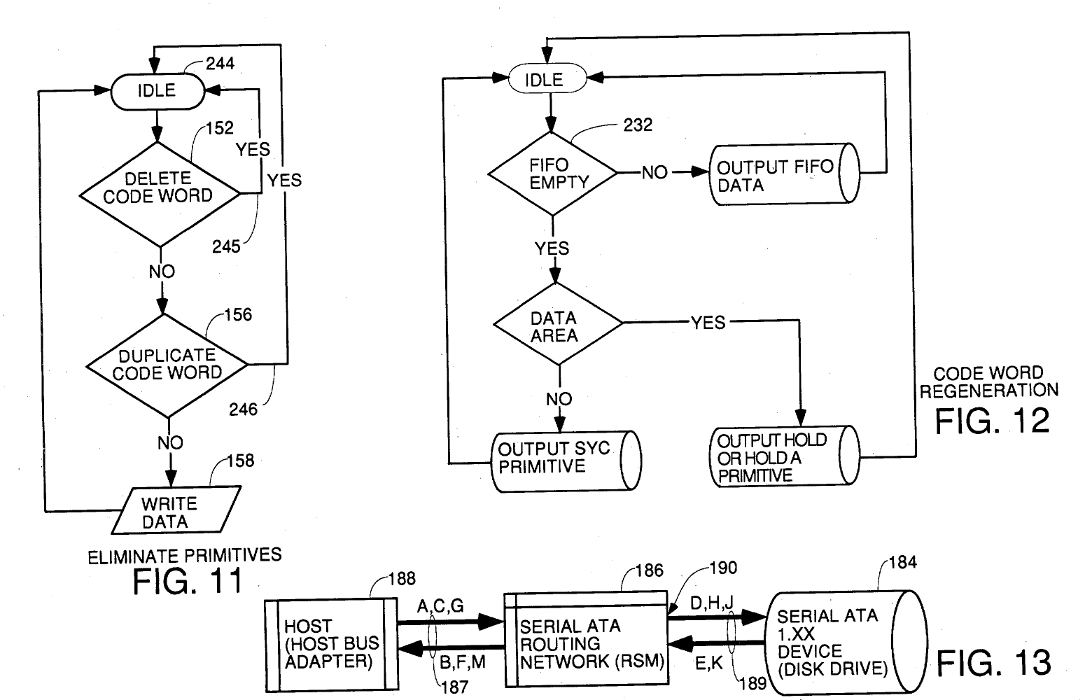

The FIFO Storage Monitor 150 monitors the full/empty status of the FIFO 154 using the read and write pointers on buses 180 and 151, and generates a FIFO empty signal on line 172. As shown in the flowchart of FIGS. 11 and 12, which illustrates the process carried out by the smart FIFO, primitive reduction is accomplished first by removing those primitives that are un-necessary by simply not storing them in the FIFO buffer, as symbolized by step 152. The FIFO empty signal is used in step 232 of FIG. 12 to control output of FIFO data and primitives on bus 224 to reconstruct the input data stream. The FIFO empty signal also causes the output multiplexer 170 to select Hold primitives for output if transmitting data but the FIFO is empty. If the FIFO is empty, a Hold primitive is inserted if during data, or a Sync primitive (idle) not during data. The Hold primitives coming in were deleted so they did not have to be stored, but they will be inserted again on the output stream if necessary such as the FIFO empties momentarily because of differing clock rates on the input and output ports causing an underflow of data to the FIFO. This can happen because the clock can be spread spectrum in serial ATA which means the transmit streams can be at 0.5% difference in frequency. Each link has its own clock. Elimination of Hold primitives and the Hold acknowledge at each output where possible saves time and FIFO space, resulting in a lower cost.

When data is being transmitted to a port on bus 224, the receiving port outputs a primitive on the return channel that indicates receive is in progress. In FIG. 7, suppose port 64 is the source port and is sending data to output port 70 via smart FIFO 72, bus 80, crossbar switch 62 and bus 71. Receive in progress primitives are coming back on the reverse channel to port 70 but they get deleted from smart FIFO 78. But they are reinserted on bus 86 and get transmitted to port 64.

Primitives or control codes that can be completely removed would include any primitive or control code that can be re-created by an output process or mechanism either directly or indirectly. For Serial ATA, these un-necessary primitives include, but not limited to, the Align (ALIGN), Hold (HOLD), Hold Acknowledge (HOLDA), Continue (CONT) and Continue data. These code words can be and are re-created at the output of the FIFO buffer so they are not stored in the smart FIFO buffer.

The serial ATA 2.0 specification requires conversion of serial ATA 1.0 RTX primitive to XRDY and HRDY to RRDY. Transformation of RTX to XRDY, and HRDY to RRDY transformation is performed by removing these primitives (RTX and HRDY) from the FIFO input data stream and inserting the proper primitive on the output side of the Smart FIFO.

Further storage reduction is accomplished by eliminating the storage of duplicate code words, as symbolized by step 156 in FIG. 11. Any duplicate code word can be removed and then re-inserted by the output stage of the FIFO buffer. The idea is to replicate at the output the same sequence of primitives and Dwords although duplicate primitives can be eliminated since one of each is enough. For Serial ATA, these primitives which can be removed by not storing them in the FIFO (except for the first instance of each) include, but are not limited to, the transmit ready (X_RDY), reception OK (R_OK), reception error (R_ERR), reception ready (RRDY), the idle character (SYNC), reception in progress (R_IP), and wait for termination (WTRM). Input logic continually monitors the data received to detect and flag duplicate code words and storing only the first in a series of code words that have the same value in the FIFO buffer. The missing code words are then re-created at the FIFO output when an empty condition is detected by the FIFO storage monitor 150, including the ALIGN and CONT primitives, and “junk data”. If input data is not a code word or duplicated code word, it is stored in the FIFO, as symbolized by step 158.

### Code Word Regeneration

As previously mentioned, the Smart FIFO is designed to eliminate from storage, or store only the first of a series of repetitive code words in the FIFO buffer 154. The output stage of the FIFO buffer has the responsibility for regenerating the missing code words removed by the input control logic. As shown in the flowchart of FIG. 12, the output stage replicates the last code word output from the FIFO when an empty condition is detected. Because the first primitive of each primitive that cannot be deleted is stored in the FIFO, the process of FIG. 12 just re-generates the primitive by not incrementing the read pointer which is sitting on the primitive to be re-inserted. Based upon control bits stored in the FIFO along with the data value, the output stage is able to insert specific primitives when the FIFO is empty. For example, a specific code word can be inserted into the output data stream if the current transmission segment indicates a user data area.

Regeneration of primitives on the output data stream is controlled by the switch control state machine or microprocessor 175 using knowledge gained by monitoring the primitives that were stored in the FIFO 154 and knowledge gained from the other port in the transaction and by controlling the read pointer by controlling read control circuit 182. Specifically, suppose a FIS has an X_RDY, and SOF, some data, an EOF and a WRTM primitive stored in FIFO 154. The switch control knows all these primitives are stored and knows, from communication with read control 182 via bus 242 that the read pointer on bus 180 is sitting on the X_RDY primitive stored in the FIFO. The switch control circuit is also coupled to all the other ports in the RSM via a multiplexer 248 which has an output line 250 coupled to the switch control 175 and has input lines 252 coupled to all the other ports in the RSM. The switch control knows it cannot release the data of the FIS in FIFO 154 until it gets an R_RDY back from the other port. The switch control 175 also knows that the R_RDY has not arrived from the other port in the transaction by reading the route header data and by controlling the multiplexer selection of input by a control signal on line 254 to select the input coupled to the port which is coupled to the other port in the transaction. Because the switch control knows that the other port has not yet sent an R_RDY, it tells read control 182 by data or control signals on bus 242 to not increment the read pointer that is sitting on the X_RDY. This causes the FIFO to continually output an X_RDY primitive until the other port sends an R_RDY on the back channel. When that happens, the switch control 175 releases the read control circuit 182 to start incrementing the read pointer so the payload data can be sent. The payload data is then sent until the read pointer falls on the WTRM primitive. This primitive signals the end of the payload data and requires an ROK or an reception error primitive on the back channel to complete the transaction. The switch control detects when the read pointer is on the WTRM primitive and tells the read control 182 via signals on bus 242 to stop incrementing the read pointer. The WTRM primitive is then continually sent out on bus 224 until the switch control 175 detects an ROK or error primitive coming back from the port which is receiving the data via the back channel and multiplexer 248. The switch control then unlocks the route and releases the crossbar switch and signals the multiplexers 170 and 171 to select the Sync primitives via bus 240 for continuous output since the FIFO 154 will be completely empty since the Sync primitives (or align primitives) entering on bus 162 will never be stored. The switch control will count the number of Sync primitives sent, and will generate switch control signals to cause multiplexer 171 to pick an Align primitive to send periodically and then go back to sending Sync primitives.

The block diagram of FIG. 10 describes the general architecture of the Smart FIFO. Information from the link layer enters the Smart FIFO module in the form of a 32-bit Dword on bus 162 with control bits that characterize the currently received information. A receive clock for the Dword is received on line 159 The Write Control Module 160 determines the storage address by generating a write pointer on bus 161, and is responsible for generating a write strobe on line 163 allowing data to be stored provided that it is not an unnecessary code word such as a Hold, Hold Acknowledge, Continue or Continue Data. The K28_Dot_{—}3 Detection logic 164 monitors the incoming data stream to determine if the received Dword is an un-necessary or duplicate primitive or data and disables the write control logic 160 by a signal on line 166 or 168 (for control word or duplicate control word, respectively) thereby preventing those primitive from being stored in the FIFO but allowing data to be stored. If the incoming bits are a primitive, they will have a K28.3 bit pattern that indicates they are a primitive. If they are data, they will not. When a primitive is detected, the Primitive signal on line 165 is activated. If the bits are data, the signal on line 167 is activated. A receive error causes the signal on line 169 to be activated, and if the data is scrambled, the signal on line 171 is activated. Circuit 164 also detects duplicate primitives. A signal on line 166 is activated if the incoming bits are a primitive or other bits that are not to be written in the FIFO 154, and a signal on line 168 is activated if the incoming primitive is a duplicate.

Read control circuit 182 generates the read address pointer on bus 180. It receives a signal on line 228 that indicates the connection is made. The signal on line 230 enables the FIFO after some initialization. A signal on line 232 indicates whether the FIFO 154 is to be read or written to.

An output data multiplexer comprised of switches 170 and 171 selects one of three data sources for output depending upon the input signals FIFO Empty on line 172 or Data Area on line 174. The Data Area signal on line 174 is activated by the circuit 164 when the bits being received are between an SOF and and EOF primitive meaning it is payload data. The Data Area signal is passed out of the FIFO on line 174 to the read control 182 and the multiplexer 171. Based upon these input signals and in order of priority the multiplexor output is as follows:

1. If the FIFO Empty signal is active and the FIFO Data Area output bit indicates the current information is within a FIS, then the HOLDA primitive or other appropriate primitive on primitive look up path 240 is selected for output thereby reconstructing the input stream. The HOLDA and other primitives are either hard wired or can be called up from memory or primitive look up table.

2. If the FIFO empty signal is active, the output and the FIFO Data Area output bit is false indicating that the information contained in the FIFO buffer is not part of an FIS. In this case, the last primitive is replicated, and this will be a SYNC or other appropriate primitive.

3. If the FIFO is not empty, then the Dual Port RAM data output on bus 176 is selected.

The Dual Port RAM is divided into two partitions each with separate read/write controls operating at different clock frequencies. The First partition stores the DWORD and type information from the RSM Link module. This partition is a Dual Port RAM organized as 32 bit words storing primitives and data received from the RSM link interface. The second partition is a 4-bit word that stores the control information to be used by the output state for flow control or passed to the attached data port. A separate read address bus 180 running at the reference clock rate, provides the read address pointer to select the Dual Port RAM location in FIFO 154 for output on bus 176. The read pointer is monitored by storage monitor 150 as is the write address on bus 151. An impending overflow is signalled by the storage monitor 150 by the signal on bus 237 to read control 182. It responds by generating a HoldReq signal on bus 235 which is sent to the port which is receiving the data for transmission on the reverse channel to the port which is sending the data and tells it to stop sending data temporarily.

The Smart FIFO is designed to eliminate from storage, or store only the first of a series of ATA primitives in the FIFO buffer. As shown in FIG. 12, the output stage simply replicates the last primitive output from the FIFO when an empty condition is detected. FIG. 11 is the process implemented by Write Control circuit 160 in FIG. 10 to eliminate duplicate primitives for some primitives and all of certain other primitives. If a data FIS is present, and the FIFO is empty, the output stage inserts the HOLDA primitive to avoid unnecessary flow control. Step 244 indicates that the write control does the process of FIG. 11 on every 32-bit clock period. Step 152 determines if the incoming code word can be deleted by the signal on line 166. If so, path 245 is taken and the writer pointer is not incremented.Step 156 determines if the incoming code word can be deleted by the signal on line 168. If so, path 246 is taken and the writer pointer is not incremented. Certain primitives, as determined by circuit 164, such as EOF and SOF and the first XRDY, are not deleted. All other primitives are deleted and duplicates of the primitives that cannot be deleted are deleted. If neither is true, the write control circuit 160 increments the write pointer address and writes the data into the FIFO 154.

Logic at the FIFO output continually monitors the DataArea signal on line 174 looking for the start of a serial ATA FIS. A low to high transition on line 174 is detected to store the current FIFO Read address for use in the event of a data collision. Collisions are detected by the RSM State Machine, which must also examine the characteristics of the attached device to determine if this port represents the point of origin. If the State Machine detects a collision, the previously saved read pointer is restored to the FIFO Read address pointer in preparation for a connection retry.

The advantage of stripping out the primitives before storage in the FIFO is that is saves a great deal of memory.

### Switch Control

A circuit 175 reads the route header information in 2.xx FIS stored in FIFO buffer memroy 154 via data path 177 when it recognizes an SOF primitive. It also looks for RRDY, XRDY, HRDY and all the other primitives so that it can monitor the state of handshakes. Circuit 175 then generates the appropriate switch control commands on bus 179 to the crossbar switch (part of bus 80 in FIG. 7) to control the crossbar switch 62 in FIG. 7 to route the data in the FIFO to the correct output port. When a primitive has been deleted, the switch control 175 is informed by the signal on line 165 and determines what primitive has been deleted by the data on bus 162 to which it is coupled. Switch control circuit 175 also generates an appropriate primitive select signal on line 242 to cause multiplexer 171 to insert the proper primitive into the output data on bus 224 based upon the stage of the handshake or transaction being implemented at any particular time so as to do the routing protocol, protocol conversions, the discovery protocol etc.

Circuit 181 reads the forward route header information on bus 177 for 2.xx FIS and changes the data as it passes through the FIFO to point to the reverse route. The forward route header and reverse router header are stored in memory in circuit 181 for use in protocol conversion operations. Stripping off of 2.xx route header information and 2.xx primitives can also be accomplished by either of circuits 175 or 181 or stripping of route headers can be accomplished by read control 182 which generates read addresses such that the router header information in a 2.xx FIS addressed to a 1.xx device is skipped over when a 2.xx FIS is read for output.

### Protocol Conversions

To make a serial ATA 1.0 device work in a serial 2.0 system which has routing information in route headers and 2.0 primitives that the 1.0 device does not understand, it is necessary to do protocol conversion so that a 2.0 host can send out a 2.0 primitive like RTX and it will be converted in the smart FIFOs or RSMs along the route to an X_RDY primitive that the 1.0 device understands. The protocol conversion described here is serial ATA to specific. The smart FIFO is the most logical place to do the protocol conversion since it strips out primitives and re-inserts them when the data is output so 2.0 primitives can be stripped before storage and the corresponding 1.0 primitives can be re-inserted.

### Serial ATA 1.xx Devices Attached to Serial ATA 2.xx Routing Network

Transformation of Serial ATA 2.0 protocol into Serial ATA 1.0 protocol allows attaching Serial ATA 1.0 storage devices to a Serial ATA 2.0 network. The Serial ATA 2.xx specification allows for the attachment of Serial ATA 1.xx devices to a Serial ATA 2.xx or greater routing network.

The Serial ATA 2.xx protocol includes a route header, as well as new primitives or codewords that need to be changed to serial ATA 1.xx primitives. Further, the route header of a 2.xx packet must be removed before the packet is sent to a 1.xx device.

The route header is a field inserted at the beginning of a Serial ATA 2.xx routing FIS (Frame Information Structure) and contains information that directs a routing FIS along a route from host to device, or device to host. The protocol conversion process provides a method for recognizing the route header, and the attachment of a Serial ATA 1.xx device. For all serial ATA 1.xx devices, the route extension (route header information field 50 in FIG. 4) is stored in a holding buffer and removed from the transmission path to the Serial ATA 1.xx device. The route extension is then re-inserted at the beginning of a data transmission that occurs from the device along a reverse route.

The protocol conversion process deletes the route extension from the smart FIFO output transforming a Serial ATA 2.xx data stream to a Serial ATA 1.xx compliant data structure.

Codeword Primitives specific to Serial ATA 2.xx have no meaning to Serial ATA 1.xx devices are recognized by the smart FIFO and replaced with an appropriate Serial ATA 1.xx Codeword Primitive.

The protocol conversion process is triggered by the recognition that a Serial ATA 1.xx device is attached to the port the smart FIFO is attached to. The existence of a Serial ATA 1.xx device connected to a port, is indicated by the EOT (End of Table) bit located in the route extension field indicating the port examining the End of Table bit is the last port on the route even though the port knows it is connected to a device.

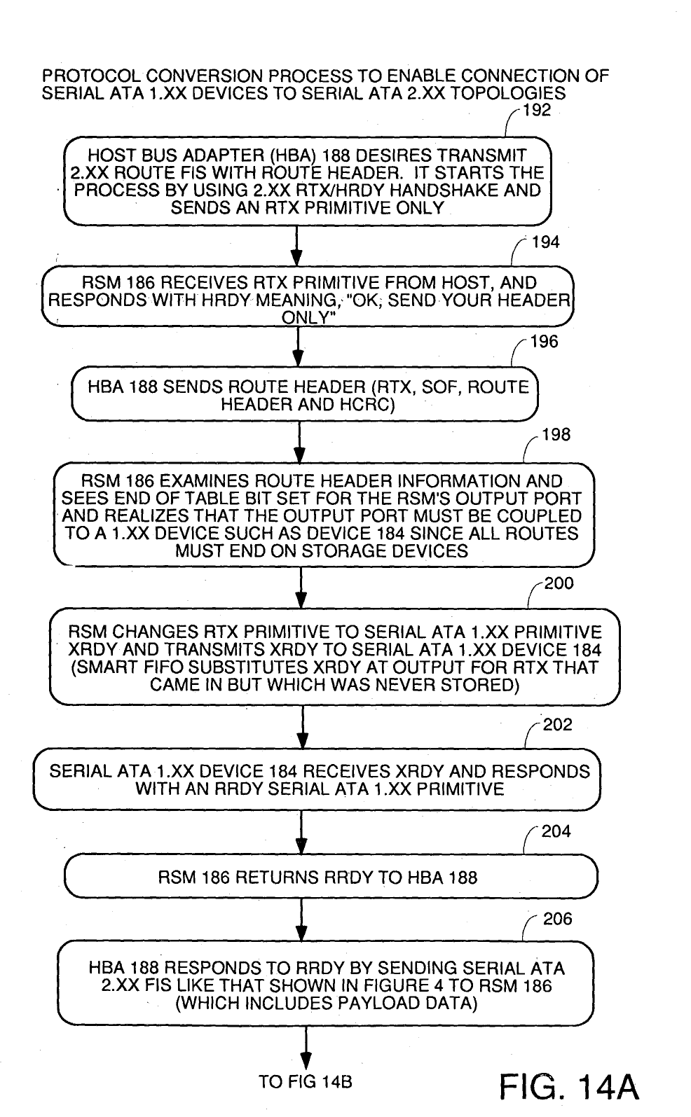

FIG. 13 illustrates a typical topology where a 1.xx storage device 184 is coupled through an RSM 186 to a 2.xx host bus adapter 188 and host computer. The protocol conversion works as follows using FIG. 13 as an example.

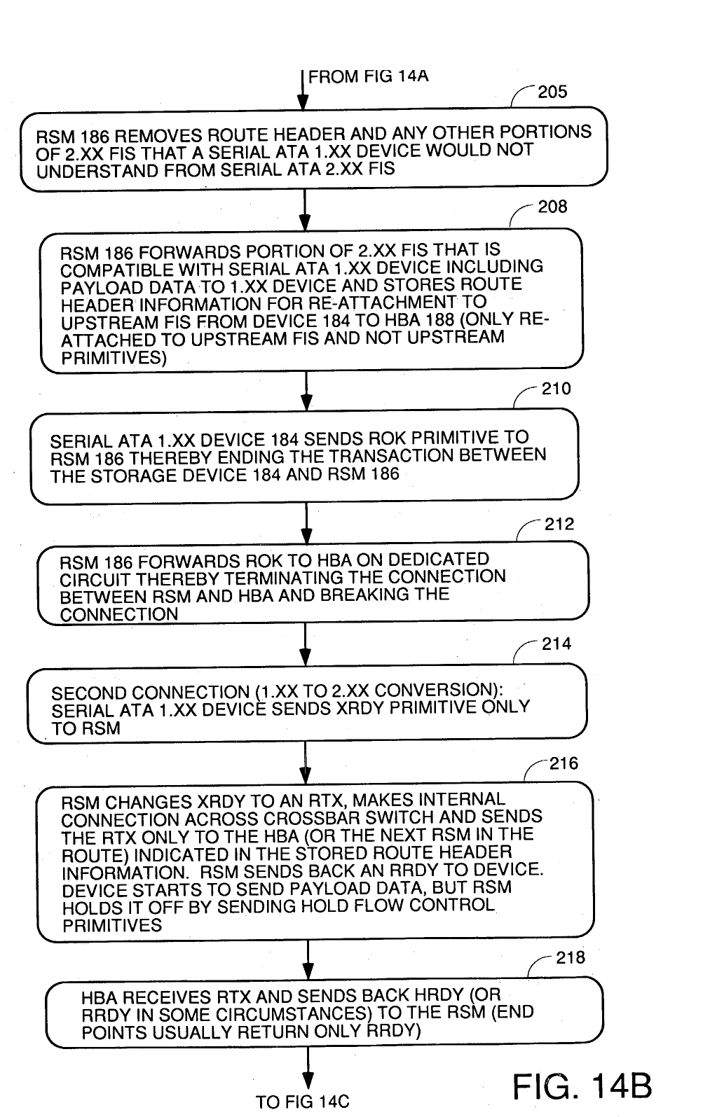

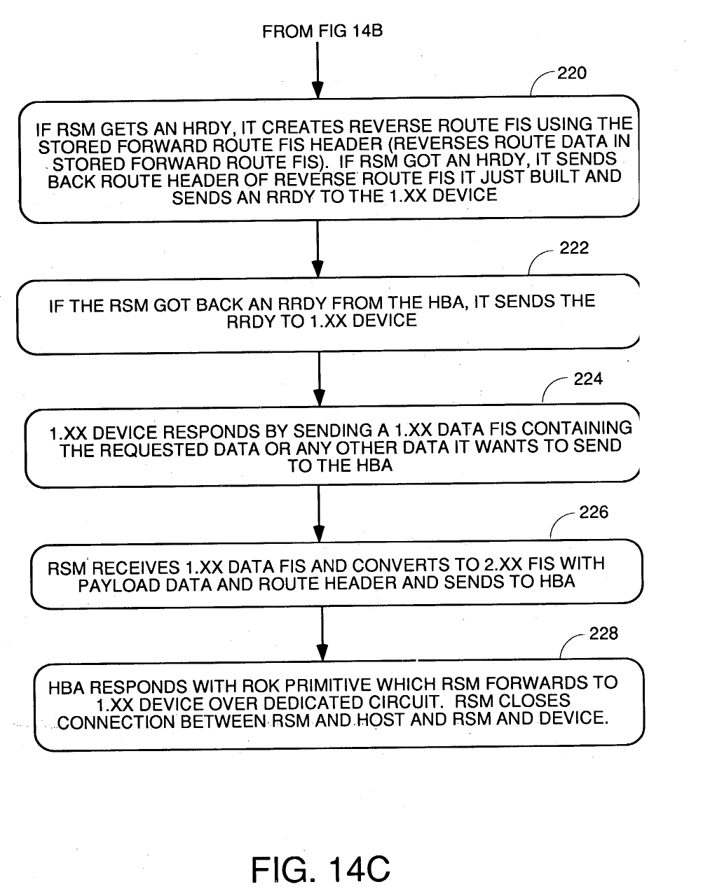

FIGS. 14A through 14C illustrate the protocol conversion steps of a downstream transaction from a serial ATA 2.xx host to a serial ATA 1.xx storage device and a second upstream transaction from the serial ATA 1.xx device to the same serial ATA 2.xx host which initiated the first transaction. Step 192 represents the process of serial ATA 2.xx host HBA 188 in FIG. 13 initiating a transaction with a serial ATA 1.xx device 184. We will assume it is a read transaction and the first transaction just tells the device what data to read and the second transaction actually transfers the requested data back to the host. Step 192 is the HBA 188 initiating the first transaction wherein it desires to transmit a 2.xx route FIS with a route header using the 2.xx handshake RTX/HRDY. This means that the first transmission is of an RTX primitive by the HBA to the RSM 186 when the HBA determines the link 187 is clear. The RSM responds, as symbolized by step 194, with an HRDY primitive sent out on the same port the RTX arrived on which is a signal, “send your header only”. The HBA 188 then sends the 2.xx route FIS header only which is comprised of fields 46,48, 50 and 52 in FIG. 4, as symbolized by step 196.

Step 198 represents the process in the RSM smart FIFO of examining the route header information and determining that the end of table bit is set for the RSMs output port. This means that the RSM output port 190 must be connected to a 1.xx device which is not route aware, and protocol conversion will be necessary since all routes must end with a storage device.

Step 200 represents the process carried out in the smart FIFO of the RSM to change the RTX primitive to a serial ATA 1.xx primitive XRDY and transmitting the XRDY to the serial ATA 1.xx device 184. This is done by never storing the RTX primitive in the smart FIFO and substituting an XRDY at the output when it would be time to transmit the RTX.

In step 202, the 1.xx device receives the XRDY primitive from the RSM and responds by sending an RRDY primitive back. This is an 1.xx primitive that means “OK to send data” and is understood by 2.xx devices also. In step 204, the RSM 186 returns the RRDY to the HBA 188. This is done in the smart FIFO in the RSM by not storing the RRDY received at the input but re-inserting it on the output at the proper time.

In step 206, the HA 188 responds to receipt of the RRDY by sending a serial ATA 1.xx FIS. The route header like that shown in FIG. 4 was sent in step 196. The payload data field 54 contains data that defines the read data the HBA wants read and sent back to it.

Step 205 represents the process of carried out in the smart FIFO of the RSM of removing the router header and any other portions of the 2.xx FIS that a 1.xx device would not understand.

In step 208, the RSM forwards the portion of the 2.xx FIS that the 1.xx device will understand (the payload data field and the CRC data and the ending primitives in FIG. 4). The router header is stored in the RSM for future use in guiding upstream primitives and constructing reverse route FIS for upstream data transmissions from the device to the host.

In step 210, the 1.xx device 184 sends back an ROK primitive to the RSM thereby ending the transaction between the RSM and the storage device and indicating the storage device received the data without errors. This allows the RSM to release the link 189 for use by other devices if any.

The ROK primitive does not contain any address data, but the RSM uses the stored route header to determine where to send the ROK primitive and sends it to HBA 188, as symbolized by step 212. Each RSM can store only one route header, so there is no ambiguity even if the are two hosts. In effect, because of the stored router header, the route between HBA 188 and device 184 is a dedicated circuit and its links will not be released for other uses until the ROK has propagated in the reverse direction across each link. When the ROK gets back to the HBA 188, the transaction to tell the device what data the host wants is over.

Step 214 represents the start of a second connection wherein the storage device sends back the requested data to the HBA 188. It starts by sending an XRDY primitive only to the RSM 186.

In step 216, the RSM converts the XRDY to an RTX and sends it to the HBA 188.

This protocol conversion is accomplished by the smart FIFO in the RSM in the manner previously described. If there were two hosts coupled to the same RSM, the RSM 186 would still know to send the RTX out the port coupled to HBA 188 since the stored route header is used by the RSM to determine where to send the RTX.

In step 218, the HBA receives the RTX and responds by sending back an HRDY, or RRDY in some circumstances, to the RSM. Usually, the HBA sends back an RRDY, but there are exceptions not relevant to the protocol conversion process being described here.

In step 220, if RSM gets an HRDY, it creates a reverse route FIS using the stored forward route FIS header (reverses route data in stored forward route FIS route header data). The reverse route header is built by reversing the route data in the route header to point to the upstream path to HBA 188. If the RSM got an HRDY, it sends back to the HBA the route header of reverse route FIS it just built, and sends an RRDY to the 1.xx device. If an RRDY is received from the HBA, the RSM forwards the RRDY to the 1.xx device 184 and converts the stored forward route header to a reverse route header, as symbolized by step 222.

The 1.xx device responds to receipt of the RRDY by sending a 1.xx data FIS containing the requested data or any other data it wants to send to the HBA, as symbolized by step 224.

In step 226, the RSM receives the 1.xx data FIS and converts it to a 2.xx data FIS by re-attaching the reverse route header to the payload data and other primitives of the 1.xx data FIS. The 2.xx data FIS is then sent to the HBA 188.

In step 228, the HBA responds with an ROK primitive to the RSM which forwards an ROK primitive to the 1.xx device over the dedicated circuit defined by the reverse route header or the stored forward router header. When the ROK gets to the 1.xx device, the link 189 is closed and the transaction is over.

Although the invention has been disclosed in terms of the preferred and alternative embodiments disclosed herein, those skilled in the art will appreciate possible alternative embodiments and other modifications to the teachings disclosed herein which do not depart from the spirit and scope of the invention. All such alternative embodiments and other modifications are intended to be included within the scope of the claims appended hereto.

What is claimed is:

1. A switchable fabric interface using one or more connections over a point to point, serial topology, mass storage interface, such as Serial ATA, that allows for the connection of multiple mass storages devices to one or morehost devices such as file servers, application servers, individual computers, workstations, network attach storage devices, and protocol bridge devices to form a storage area network using serial, point to point protoco

2. A collision resolution protocol in a serial ATA topology that has more than two devices coupled together by serial ATA links, comprising the steps carried out in a node at the collision site:
receiving at a first node coupled to a data path on which a collision will occur a primitive from a second node that indicates said second node desires to transmit a data packet with a header that includes routing data to said first node, and responding thereto by sending back a primitive that gives permission to said second node to send only said header of said data packet;
receiving at a third node coupled to a data path on which a collision will occur a primitive from a fourth node indicating said fourth node desires to transmit a data packet with a header that includes routing data to said third node, and responding thereto by sending back a primitive that gives permission to said fourth node to send only said header of said data packet;
reading the routing data in the headers and concluding a collision will occur;
deciding which initiator node will have to back off and listen in any way;
sending a message to the losing initiator node telling it that it will have to listen; and
completing the transaction by sending data to the losing initiator node.

3. A protocol conversion protocol, comprising the steps:
receiving from a serial ATA 2.xx initiator node serial ATA 2.xx primitives or serial ATA 2.xx FIS having a prepended route header field which defines a route directed to a serial ATA 1.xx device which has no route awareness capability;
converting said serial ATA 2.xx primitives received from said serial ATA 2.xx initiator node to serial ATA 1.xx primitives and forwarding said serial ATA 1.xx primitives to said serial ATA 1.xx device;
receiving any serial ATA 1.xx primitives back from said serial ATA 1.xx device, and forwarding said serial ATA 1.xx primitives to said serial ATA 2.xx initiator node;
receiving serial ATA 2.xx data FIS with appended route header from said serial ATA 2.xx initator node in response to receipt by said serial ATA 2.xx initiator node of said serial ATA 1.xx primitive from said serial ATA 1.xx device;
stripping off the route header field and any other fields or primitives in said serial ATA 2.xx data FIS which said serial ATA 1.xx device will not understand, and forwarding the remainder of said FIS to said serial ATA 1.xx device, and storing said route header of said serial ATA 2.xx data FIS which was stripped therefrom;
receiving from said serial ATA 1.xx device a serial ATA 1.xx primitive that terminates said transaction and forwarding said serial ATA 1.xx primitive to the serial ATA 2.xx initiator node identified in said stored router header to close the connection between said serial ATA 2.xx initiator node and said serial ATA 1.xx device.

4. A process for routing in serial ATA systems, comprising:
receiving a serial ATA 2.xx route header or a serial ATA 2.xx router header which is part of a serial ATA 2.xx FIS, and using routing information therein to route the header or the entire serial ATA 2.xx FIS to a destination device; and
as said serial aTA 2.xx route header is passed through a serial ATA 2.xx topology, altering the routing data in said route header to point to the reverse path.

5. A router and buffer for a serial ATA topology that allows more than one host and storage device to be coupled together by serial ATA buses, comprising:
a plurality of ports, each for coupling to a serial ATA bus;
a crossbar switch coupled to each port;
a port specific data structure coupled to each port;
and wherein each port comprises:
circuitry for reading route data in a header of an incoming FIS and controlling said crossbar switch to make the appropriate connections between ports in said router to implement a connection defined in the route data of said header;
circuitry for altering said route data in a header of an incoming FIS to define reverse route header data;
circuitry to receive a FIS back from the destination node defined by said route data for a forward route which contains a data element which defines the FIS as a reverse route FIS and recognize that said FIS is a reverse route FIS and use said reverse route header data to route said reverse route FIS.

6. The apparatus of claim 5 wherein each port further comprising means for detecting and resolving collisions using a header transmission only protocol.

7. The apparatus of claim 5 wherein each port further comprises means for detecting when a serial ATA 1.xx device which is not route aware is coupled to a port and for performing appropriate protocol conversions to allows said serial ATA 1.xx device to communicate with other serial ATA 2.xx devices in the topology in which said router and buffer will be connected.

8. The apparatus of claim 5 wherein said buffer includes means for removing primitives and data deemed unnecessary from the incoming data before storage in a FIFO organized memory, and for regenerating or duplicating at the output of said FIFO the removed primitives or data at least enough to not alter the functionality of the output data stream.

9. The apparatus of claim 5 wherein said circuitry to alter said route data to define the reverse path does not lock the ports for a forward or reverse route defined by said route data.

10. A computer readable memory having stored thereon a data structure comprising:
1) an RTX primitive;
2) a separator data item which separates said route data header from said RTX primitive;
3) a route data header;
4) a field of error detection and correction data calculated on data items 1 through 3;
5) a payload data section;
6) a field of error detection and correction data calculated on said payload data section;
7) a separator data item that separates fields 6 and 8.
8) a WTRM primitive; and
